(19) United States
(12) Patent Application Publication
(10) Pub. No.: US 2021/0371197 A1
(43) Pub. Date: Dec. 2, 2021

(54) RECONFIGURABLE BAG HOLDER DEVICE

(71) Applicant: Harold Sokyrka, Saskatoon (CA)

(72) Inventor: Harold Sokyrka, Saskatoon (CA)

(21) Appl. No.: 16/757,498

(22) PCT Filed: Oct. 24, 2018
(86) PCT No.: PCT/IB2018/058298

§ 371 Date: Apr. 20, 2020

Related U.S. Application Data
(60) Provisional application No. 62/576,843, filed on Oct. 25, 2017.

(51) Int. Cl. B65F 1/14

(52) U.S. Cl. CPC B65F 1/1415

(57) ABSTRACT

A reconfigurable bag holder device is provided. In some embodiments, the device may include a bag retaining structure which may comprise one or more rails and one or more corner joiners. Preferably, the bag retaining structure may comprise a generally rectangular shape formed by four rails and four corner joiners with each rail joined to two other rails by two corner joiners. The rails may be adjustable in length thereby allowing the bag retaining structure to be adjustable in size and shape. The device may comprise one or more legs which may be coupled to the bag retaining structure. Optionally, portions of a bag may be secured to the bag retaining structure by one or more rail retainers which may be frictionally coupled to a rail so that a portion of the bag is frictionally retained between the rail and a rail retainer.

### CROSS REFERENCE TO RELATED APPLICATIONS

This application claims priority to and the benefit of the filing date of U.S. Provisional Application No. 62/576,843, filed on Oct. 25, 2017, entitled “RECONFIGURABLE BAG HOLDER DEVICE”, which is hereby incorporated by reference in its entirety.

### FIELD OF THE INVENTION

This patent specification relates to the field of bag holding devices. More specifically, this patent specification relates to bag holding devices that are reconfigurable to accommodate a plurality of different sized bags and to perform a plurality of functions.

### BACKGROUND

A bag is commonly known as a container made of flexible material with an opening at the top which is used for carrying and containing objects. While the flexible material forming the bag provide the benefits of enabling the bag assume various shapes and to be collapsible in nature, these benefits can also make the bag difficult to manage. For example, bags tend to be unable to maintain their shape which can make placing objects into and removing objects from them a challenge. While some devices exist to hold bags in an open position, bags held by these devices can easily become dislodged resulting in the contents of the bag being spilled. Additionally, these devices often are only able to accommodate one size or a limited number of different sized bags, and these devices restrict the removal of the bags when full of objects and in many cases the bags tear so that the objects falls out of the bag. Furthermore, these devices are limited in function so that they are only able to hold a bag open and only over a flat surface.

Therefore, a need exists for a novel bag holding devices. There is also a need for novel bag holding devices that are reconfigurable to accommodate a plurality of different sized bags. A further need exists for novel bag holding devices which are able to securely hold a bag so that bags are not easily dislodged from the devices. Finally, a need exists for novel bag holding devices which are not limited to a single function, but which are reconfigurable to perform a plurality of functions.

### BRIEF SUMMARY OF THE INVENTION

A reconfigurable bag holder device is provided. The device may be configured to hold or secure objects, including bags and plates. In some embodiments, the device may include a bag retaining structure and one or more legs, such as a first leg, that may be coupled to the bag retaining structure. The bag retaining structure may include a first corner joiner having a first rail coupler, a second rail coupler, and a leg coupler. A first rail may be coupled to the first rail coupler, and a second rail may be coupled to the second rail coupler.

In further embodiments, the device may include a bag retaining structure which may comprise one or more rails and one or more corner joiners. Preferably, the bag retaining structure may comprise a generally rectangular shape formed by four rails and four corner joiners with each rail joined to two other rails by two corner joiners. The rails may be adjustable in length thereby allowing the bag retaining structure to be adjustable in size and shape. The device may comprise one or more legs, which may be adjustable in length, with each leg coupled to the bag retaining structure. Optionally, a leg may be coupled to the bag retaining structure by being coupled to a corner joiner, or a leg may be coupled to the bag retaining structure by being coupled to a handle coupler which may be coupled to a rail.

In still further embodiments, the device may include a first corner joiner, a second corner joiner, a third corner joiner, and a fourth corner joiner, and each corner joiner may comprise two rail couplers and a leg coupler. The first corner joiner may have a first rail coupler, a second rail coupler, and a first leg coupler. The device may further include a first rail, a second rail, a third rail, and a fourth rail, and the first rail may be coupled to the first rail coupler and the second rail may be coupled to the second rail coupler. Preferably, at least one rail may be adjustable in length. The device may also include a first leg, a second leg, a third leg, and a fourth leg, and the first leg may be coupled to the first leg coupler.

In further embodiments, the device may include one or more bag retainers. Portions of a bag may be secured to the bag retaining structure by one or more rail retainers which may be frictionally coupled to a rail so that a portion of the bag is frictionally retained between the rail and a rail retainer.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a perspective view of an example of a reconfigurable bag holder device according to various embodiments described herein.

FIG. 2—FIG. 2 illustrates a perspective view of another example of a reconfigurable bag holder device according to various embodiments described herein.

FIG. 3—FIG. 3 shows a perspective view of still another example of a reconfigurable bag holder device that is holding a bag according to various embodiments described herein.

FIG. 4—FIG. 4 depicts a perspective view of an example of a handle coupler according to various embodiments described herein.

FIG. 5—FIG. 5 illustrates a top perspective view of an example of a corner joiner according to various embodiments described herein.

FIG. 6—FIG. 6 shows a bottom perspective view of an example of a corner joiner according to various embodiments described herein.

FIG. 7—FIG. 7 depicts a sectional, through line 7-7 shown in FIG. 5, elevation view of an example of a corner joiner according to various embodiments described herein.

FIG. 8—FIG. 8 illustrates a perspective view of an example of a rail retainer according to various embodiments described herein.

FIG. 9—FIG. 9 shows a rear perspective view of an example of a side wall according to various embodiments described herein.

FIG. 10—FIG. 10 depicts a perspective view of an example of a foot according to various embodiments described herein.

FIG. 11—FIG. 11 illustrates a perspective view of a user manipulating an exemplary reconfigurable bag holder device via an exemplary shoulder strap according to various embodiments described herein.

FIG. 12—FIG. 12 shows a top perspective view of another example of a corner joiner according to various embodiments described herein.

FIG. 13—FIG. 13 depicts a bottom perspective view of another example of a corner joiner according to various embodiments described herein.

FIG. 14—FIG. 14 illustrates a perspective view of another example of a rail retainer according to various embodiments described herein.

FIG. 15—FIG. 15 shows a sectional, through line 15-15 shown in FIG. 14, elevation view of another example of a rail retainer according to various embodiments described herein.

FIG. 16—FIG. 16 depicts a perspective view of yet another example of a reconfigurable bag holder device according to various embodiments described herein.

FIG. 17—FIG. 17 illustrates a bottom perspective view of an example of a corner joiner depicting a horizontal rail plane formed by a projected intersection between the first rail coupler and second rail coupler according to various embodiments described herein.

FIG. 18—FIG. 18 shows a partial perspective view of an example of a rail according to various embodiments described herein.

FIG. 18—FIG. 18 depicts a partial perspective view of an example of a leg according to various embodiments described herein.

FIG. 20—FIG. 20 shows a perspective view of yet another example of a reconfigurable bag holder device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

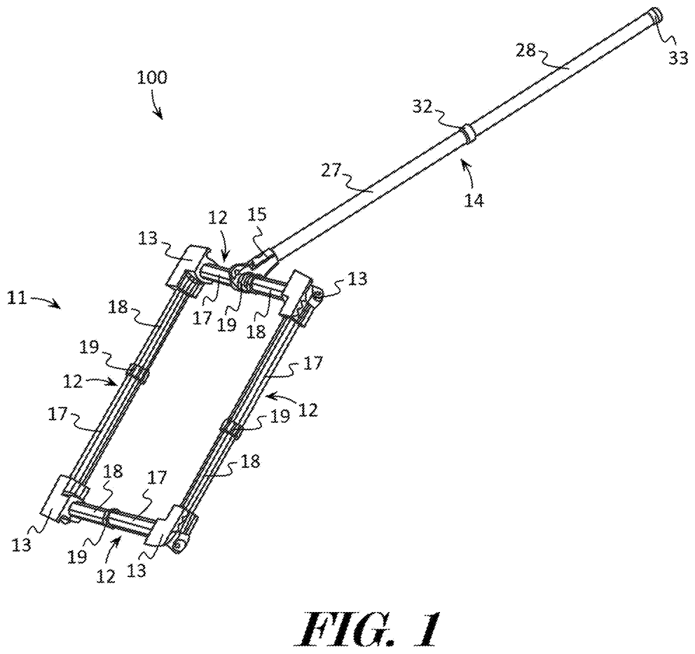

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts of the invention. Hence, specific dimensions and other physical characteristics relating to the embodiments disclosed herein are not to be considered as limiting, unless expressly stated otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new bag holding device that is reconfigurable for a plurality of uses is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by example and through referencing the appended figures representing preferred and alternative embodiments. FIGS. 1-3 illustrate examples of a reconfigurable bag holder device (“the device”) 100 according to various embodiments. In some embodiments, the device 100 may comprise a bag retaining structure 11 which may comprise one or more rails 12 and one or more corner joiners 13. Preferably, the bag retaining structure 11 may comprise a generally rectangular shape formed by four rails 12 and four corner joiners 13 with each rail 12 joined to two other rails 12 by two corner joiners 13. The rails 12 may be adjustable in length thereby allowing the bag retaining structure 11 to be adjustable in size and shape. The device 100 may comprise one or more legs 14, which may be adjustable in length, with each leg 14 coupled to the bag retaining structure 11. Optionally, a leg 14 may be coupled to the bag retaining structure 11 by being coupled to a corner joiner 13, or a leg 14 may be coupled to the bag retaining structure 11 by being coupled to a handle coupler 15 which may be coupled to a rail 12 or other element of the device. Portions of a bag 200 may be secured to the bag retaining structure 11 by one or more rail retainers 16 which may be frictionally coupled to a rail 12 so that a portion of the bag 200 is frictionally retained between the rail 12 and a rail retainer 16.

As shown in FIGS. 1-3, the device 100 may optionally comprise a bag 200 which may be removably coupled to the device 100 by the bag retaining structure 11 which may be used to secure portions of the bag 200, such as the mouth or opening of the bag 200 in an open position, so that a user 300 may easily place objects into and out of the bag 200. A bag 200 may be made from flexible materials, such as paper, plastic, natural fabric, synthetic, fabric, etc., and a bag 200 may comprise any shape or size. Preferably, portions of the bag 200 may be placed over one or more elements of the bag retaining structure 11 and optionally secured by one or more rail retainers 16 to one or more rails 12 and/or by one or more corner retainers 26 to one or more corner joiners 13. In some embodiments, a bag retaining structure 11 may have a generally rectangular shape which may be formed by four generally linear shaped rails 12 and four corner joiners 13 with each rail 12 joined to two other rails 12 by two corner joiners 13.

In other embodiments, a bag retaining structure 11 may be configured in any other shape. For example, a bag retaining structure 11 may be configured with a generally triangular shape which may be formed by three generally linear shaped rails 12 and three corner joiners 13. As another example, a bag retaining structure 11 may be configured with a generally hexagonal shape which may be formed by six generally linear shaped rails 12 and six corner joiners 13. In alternative embodiments, one or more rails 12 may comprise a curved shape or any other shape thereby giving all or portions of the bag retaining structure 11 a curved or rounded shape. For example, bag retaining structure 11 may comprise two rails 12 opposingly positioned to each other which may each comprise a generally concave curve shape relative to each other and the bag retaining structure 11 may also comprise two rails 12 opposingly positioned to each other which may each comprise a generally linear shape with the four rails coupled together via four corner joiners 13 thereby giving the bag retaining structure 11 a stadium shape (a two-dimensional geometric shape constructed of a rectangle with semicircles at a pair of opposite sides; alternative names include discorectangle and obround).

The device 100 may comprise one or more rails 12 which may form the major portions of the bag retaining structure 11. In some embodiments, a rail 12 may comprise a fixed length, while in preferred embodiments; a rail 12 may comprise an adjustable length so that the rail 12 may be moved into and between a relatively longer length and a relatively short length. For example, a rail 12 may be extendable into and between a length of eight inches and a length of twenty four inches.

In preferred embodiments, an adjustable length rail 12 may comprise one or more minor rail sections 17 which may be retracted into and extended out of one or more major rail sections 18 in a telescoping manner. In other embodiments, an adjustable length rail 12 may comprise one or more rail sections 17, 18, which may be removably coupled together to form a rail 12 having various lengths. For example, by coupling three rail sections 17, 18, together a relatively shorter length rail 12 may be formed than a rail 12 having four or more rail sections 17, 18. Rail sections 17, 18, may be made from aluminum, carbon fiber, steel, other metal alloys, hard plastics, such as polyethylene (PE), Ultra-high-molecular-weight polyethylene (UHMWPE, UHMW), polypropylene (PP) and polyvinyl chloride (PVC), polycarbonate, nylon, Poly(methyl methacrylate) (PMMA) also known as acrylic, fiberglass, or any other suitable material that is preferably lightweight yet strong enough to support varying degrees of weight.

A rail 12 may comprise any shape, and preferably an elongated shape, having a length substantially greater than its width and height. In some embodiments, a rail 12 may comprise an elongated cylindrical shape. In other embodiments, a rail 12 may comprise an elongated hexagonal prism shape. In alternative embodiments, a rail 12 may comprise an elongated triangular prism shape, an elongated rectangular prism shape, and elongated oval shape, or any other shape including combinations of shapes. For example, the majority and central portion of a rail 12 may comprise an elongated hexagonal prism shape, while each end of the rail 12 (the portions of a rail 12 configured to be coupled to a corner joiner 13) may comprise a generally cylindrical shape.

In some embodiments, a rail 12 may comprise one or more rail adjustment locks 19 which may couple two or more rail sections 17, 18, together. In some embodiments, a rail adjustment lock 19 may comprise a twist-to-lock mechanism so that by rotating all or a portion of the rail adjustment lock 19 in a first direction the rail sections 17, 18, may be separated from each other, while rotating the rail adjustment lock 19 in second direction the rail sections 17, 18, may be locked together. In other embodiments, a rail adjustment lock 19 may comprise a twist-to-lock mechanism so that by rotating the rail adjustment lock 19 in first direction the rail sections 17, 18, may be extended out of or retracted into each other, while rotating the rail adjustment lock 19 in second direction the rail sections 17, 18, may be locked together. In still other embodiments, a rail adjustment lock 19 may comprise a ball detent arrangement commonly having a ball sliding within a bored cylinder, against the pressure of a spring, which pushes the ball against the other part of the mechanism, which carries the detent that can be as simple as a hole of smaller diameter than the ball. When the hole is in line with the cylinder, the ball falls partially into the hole under spring pressure, holding the rail sections 17, 18, at that position. Additional force applied to the moving rail sections 17, 18, will push the ball back into its cylinder, compressing the spring, and allowing the rail sections 17, 18, to move to another position. In yet further embodiments, rail adjustment lock 19 may comprise a locking pin which may be inserted through one or more pin apertures in two rail sections 17, 18, thereby removably securing the rail sections 17, 18, together. In alternative embodiments, rail adjustment lock 19 may comprise any other coupling method which may be used to couple, preferably movably or removably, two or more rail sections 17, 18, together.

Turning now to FIGS. 1-3, and 5-7, the device 100 may comprise one or more corner joiners 13. In some embodiments, a corner joiner 13 may be configured to join or couple two rails 12 together. A corner joiner 13 may comprise one or more rail couplers, such as a first rail coupler 21 and a second rail coupler 22. A rail 12 may be coupled to a corner joiner 13 by inserting a portion of the rail 12 into a rail coupler 21, 22. In preferred embodiments, a first rail coupler 21 and a second rail coupler 22 may be oriented approximately 90 degrees or perpendicularly relative to each other. In other embodiments, a first rail coupler 21 and a second rail coupler 22 may be oriented between approximately 60 to 150 degrees relative to each other.

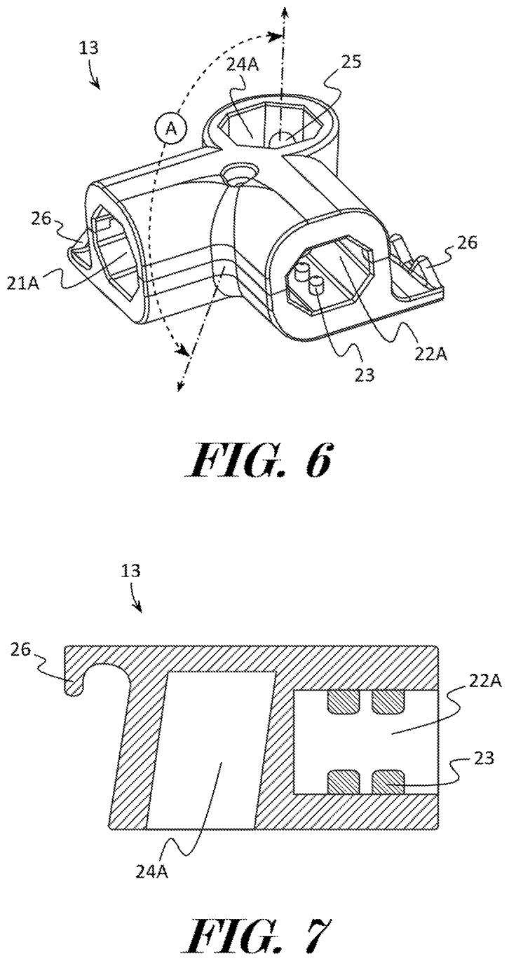

A rail coupler 21, 22, may comprise any shape which may be suitable for receiving portions, such as an end portion, of a rail 12. In some embodiments, a rail coupler 21, 22, may be configured as a female rail coupler 21A, 22A, which may form a cavity or opening (as perhaps best shown in FIGS. 6 and 7) into which portions of a rail 12 may be inserted. For example, a female rail coupler 21A, 22A, may comprise a rectangular prism shape into which a generally cylindrical portion of a rail 12 may be inserted. In preferred embodiments, a female rail coupler 21A, 22A, may comprise a shape that is complementary to the end portion of a rail 12 that may be inserted into the female rail coupler 21A, 22A. For example, a female rail coupler 21A, 22A, may comprise a hexagonal prism shape into which a generally hexagonal prism shaped portion of a rail 12 may be inserted.

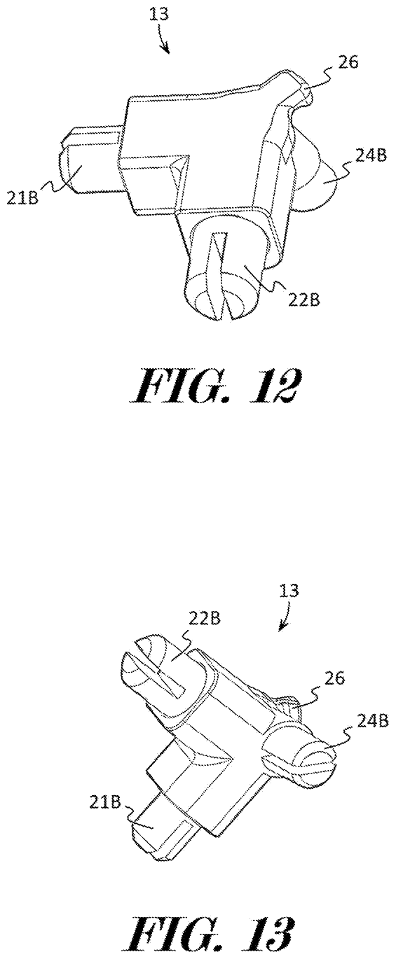

FIGS. 12 and 13 depict another example of a corner joiner 13 according to various embodiments described herein. In this example, the corner joiner 13 comprises couplers 21, 22, 24, that are configured as male couplers so that the corner joiner 13 comprises a first male rail coupler 21B, a second male rail coupler 22B, and a male leg coupler 24B. In some embodiments, a first male rail coupler 21B, a second male rail coupler 22B, and a male leg coupler 24B may be generally cylindrical in shape and may function as male elements which may be inserted into a first rail 12 having a generally hollow interior or end, a second rail 12 having a generally hollow interior or end, and a leg 14 having a generally hollow interior or end, respectively. A rail 12 may be frictionally retained to the corner joiner 13 by a press fit or frictional engagement between a male rail coupler 21B, 22B, and the interior of the rail 12. Likewise, a leg 14 may be frictionally retained to the corner joiner 13 by a press fit or frictional engagement between a male leg coupler 24B and the interior of the leg 14. While the corner joiners 13 shown in FIGS. 5-7 utilize female rail couplers 21A, 22A, and female leg couplers 24A into which portions of rails 12 and legs 14 may be inserted, and the corner joiners 13 of FIGS. 12, and 13, use male rail couplers 21B, 22B, and male leg couplers 24B, which may be inserted into rails 12 and legs 14, it should be understood that the device 100 is not limited to these attachments methods. In alternative embodiments, a rail 12 and/or leg 14 may be coupled to a rail coupler 21, 22, and/or a leg coupler 24 of a corner joiner 13 with threading or any other turn-to-lock connection method, one or more fasteners, adhesive, or any other suitable connection method.

In some embodiments, a rail 12 may be removably coupled to a rail coupler 21, 22, by being frictionally fit within the rail coupler 21, 22. In other embodiments, a rail 12 may be removably coupled to a rail coupler 21, 22, via a ball detent arrangement. For example, one or more spring loaded plungers 23 may be disposed in or on a rail coupler 21, 22, which may be removably received in a detent aperture 25 of a rail 12 to removably couple the rail 12 within the rail coupler 21, 22. As another example, a rail 12 may comprise a plunger 23 (FIG. 18) and a rail coupler 21, 22, may comprise a detent aperture 25 thereby forming a ball detent arrangement so that the ball of a plunger 23 may fit into a hole shaped detent aperture 25 in the rail coupler 21, 22. In other embodiments, a rail 12 and rail coupler 21, 22, may be removably coupled via a twist-to-lock mechanism, a locking pin, a threaded engagement, via one or more fasteners, or with any other suitable coupling method or with any other suitable coupling method. In alternative embodiments, a rail 12 may be generally non-removably coupled to or within a rail coupler 21, 22.

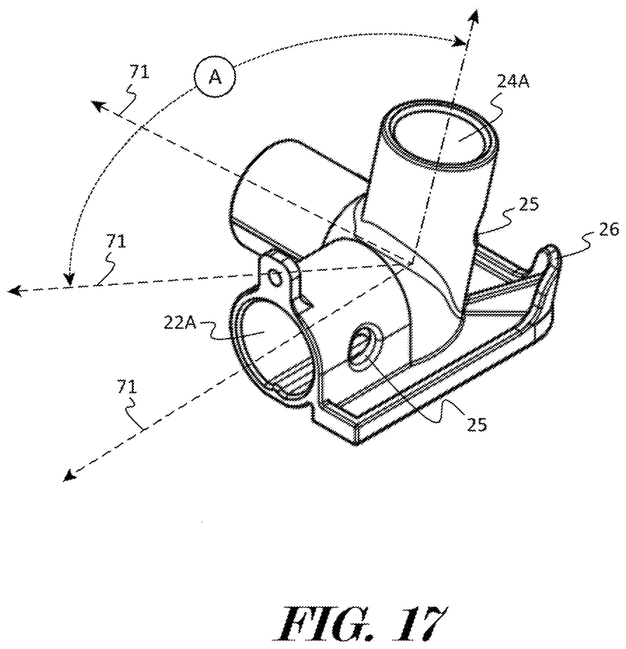

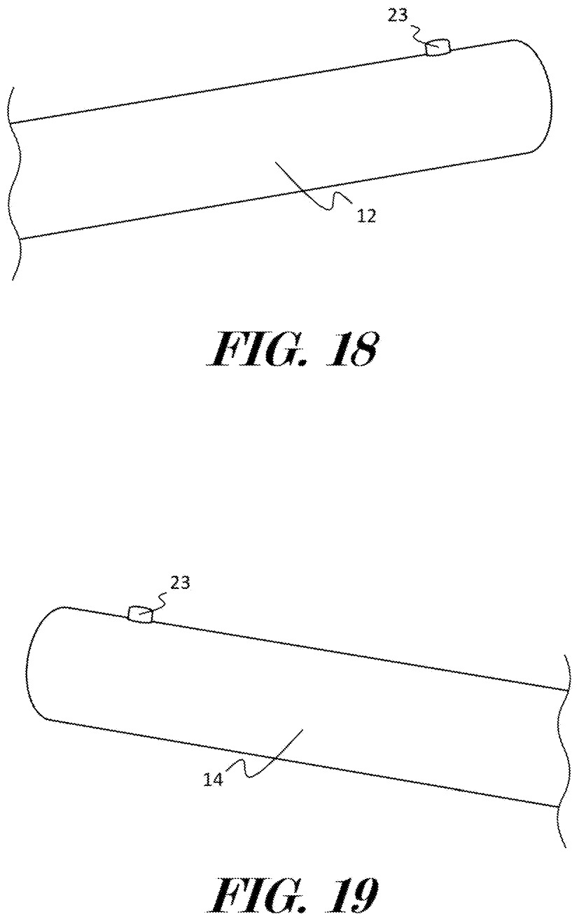

In further embodiments, a corner joiner 13 may be configured to join or couple two rails 12 and a leg 14 together. A corner joiner 13 may comprise one or more leg couplers 24 in addition to a first rail coupler 21 and a second rail coupler 22. A leg 14 may be coupled to a corner joiner 13 by inserting a portion of the leg 14 into a leg coupler 24. In some embodiments, a leg coupler 24 (and therefore its respective leg 14) may be oriented approximately 90 degrees or perpendicularly relative to a horizontal rail plane 71 (FIG. 17) formed by a projected intersection 72 between the first rail coupler 21 and second rail coupler 22 as shown by Angle A in FIGS. 6 and 17. In preferred embodiments, a leg coupler 24 (and therefore its respective leg 14) may be oriented between approximately 95 to 150 degrees, and more preferably 110 to 130 degrees relative to the horizontal rail plane 71 formed by the projected intersection 72 between the first rail coupler 21 and second rail coupler 22. In further preferred embodiments, a leg coupler 24 (and therefore its respective leg 14) may be oriented between approximately 95 to 150 degrees, and more preferably 110 to 130 degrees relative to the intersection (or projected intersection if they do not meet) of a first rail coupler 21 (and therefore its respective rail 12) and a second rail coupler 22 (and therefore its respective rail 12) as shown by angle A in FIGS. 6 and 17. In this manner, the ends of the legs 14 farthest from the corner joiners 13 may be spaced farther apart than the ends of the legs 14 coupled to the corner joiners 13. For example, a device 100 having four legs 14, four rails 12, and four corner joiners 13 may comprise a generally rectangular bag retaining structure 11 having an 18 inch square shape, while depending on the length of the legs 14, the legs 14 may contact a surface having a square shape greater than 18 inches, such as 36 square inches.

A leg coupler 24 may comprise any shape which may be suitable for receiving portions, such as an end portion, of a leg 14. For example, a leg coupler 24 may comprise a rectangular prism shape into which a generally cylindrical portion of a leg 14 may be inserted. In preferred embodiments, a leg coupler 24 may comprise a shape that is complementary to the end portion of a leg 14 that may be inserted into the leg coupler 24. For example, a leg coupler 24 may comprise a triangular prism shape into which a generally triangular prism shaped portion of a leg 14 may be inserted.

In some embodiments, a leg 14 may be removably coupled to a leg coupler 24 by being frictionally fit within the leg coupler 24. In other embodiments, a leg 14 may be removably coupled to a leg coupler 24 via a ball detent arrangement. For example, one or more spring loaded plungers 23 may be disposed in or on a leg coupler 24 which may be removably received in a detent aperture 25 of a leg 14 to removably couple the leg 14 within the leg coupler 24. As another example, a leg 14 may comprise a plunger 23 (FIG. 19) and a leg coupler 24 may comprise a detent aperture 25 thereby forming a ball detent arrangement so that the ball of a plunger 23 may fit into a hole shaped detent aperture 25 in the leg coupler 24. In other embodiments, a leg 14 and leg coupler 24 may be removably coupled via a twist-to-lock mechanism, a locking pin, a threaded engagement, via one or more fasteners, or with any other suitable coupling method or with any other suitable coupling method. In alternative embodiments, a leg 14 may be generally non-removably coupled to or within a leg coupler 24.

In some embodiments, one or more corner joiners 13 may comprise one or more corner retainers 26. Corner retainers 26 may secure or facilitate securing portions of a bag 200, such as portions of the opening of the bag 200, to a corner joiner 13. In preferred embodiments, a corner retainer 26 may comprise a generally triangular shape, while in other embodiments; a corner retainer 26 may comprise any other shape. In further embodiments, a corner retainer 26 may comprise a clip, clamp, or other type of fastener which may be used to secure or facilitate securing portions of a bag 200 to a corner joiner 13.

The device 100 may comprise one or more legs 14 which may be used to support all or portions of the bag retaining structure 11. In some embodiments, four legs 14 may be used to support a bag retaining structure 11, and a bag 200 secured thereon, above a ground surface. Preferably, a leg 14 may be coupled to the bag retaining structure 11 by inserting a portion of the leg 14 within a leg coupler 24, or otherwise coupling the leg 14 to a corner joiner 13.

In some embodiments, a leg 14 may comprise a fixed length, while in preferred embodiments; a leg 14 may comprise an adjustable length so that the leg 14 may be moved into and between a relatively longer length and a relatively short length. For example, a leg 14 may be extendable into and between a length of twelve inches and a length of thirty six inches. In preferred embodiments, an adjustable length leg 14 may comprise one or more minor leg sections 27 which may be retracted into and extended out of one or more major leg sections 28 in a telescoping manner. In other embodiments, an adjustable length leg 14 may comprise one or more leg sections 27, 28, which may be removably coupled together to form a leg 14 having various lengths. For example, by coupling three leg sections 27, 28, together a relatively shorter length leg 14 may be formed than a leg 14 having four or more leg sections 27, 28. Leg sections 27, 28, may be made from aluminum, carbon fiber, steel, other metal alloys, hard plastics, such as polyethylene (PE), Ultra-high-molecular-weight polyethylene (UHMWPE, UHMW), polypropylene (PP) and polyvinyl chloride (PVC), polycarbonate, nylon, Poly(methyl methacrylate) (PMMA) also known as acrylic, fiberglass, or any other suitable material that is preferably lightweight yet strong enough to support varying degrees of weight.

A leg 14 may comprise any shape, and preferably an elongated shape, having a length substantially greater than its width and height. In some embodiments, a leg 14 may comprise a cylindrical shape. In other embodiments, a leg 14 may comprise an elongated hexagonal prism shape. In alternative embodiments, a leg 14 may comprise an elongated triangular prism shape, an elongated rectangular prism shape, and elongated oval shape, or any other shape including combinations of shapes. For example, the majority and central portion of a leg 14 may comprise an elongated cylindrical shape, while each end of the leg 14 (the portions of a leg 14 configured to be coupled to a corner joiner 13) may comprise a generally hexagonal prism shape.

In some embodiments, a leg 14 may comprise one or more leg adjustment locks 32 which may couple two or more leg sections 27, 28, together. In some embodiments, a leg adjustment lock 32 may comprise a twist-to-lock mechanism so that by rotating all or a portion of the leg adjustment lock 32 in a first direction the leg sections 27, 28, may be separated from each other, while rotating the leg adjustment lock 32 in second direction the leg sections 27, 28, may be locked together. In other embodiments, a leg adjustment lock 32 may comprise a twist-to-lock mechanism so that by rotating the leg adjustment lock 32 in first direction the leg sections 27, 28, may be extended out of or retracted into each other, while rotating the leg adjustment lock 32 in second direction the leg sections 27, 28, may be locked together. In still other embodiments, a leg adjustment lock 32 may comprise a ball detent arrangement commonly having a ball sliding within a bored cylinder, against the pressure of a spring, which pushes the ball against the other part of the mechanism, which carries the detent that can be as simple as a hole of smaller diameter than the ball. When the hole is in line with the cylinder, the ball falls partially into the hole under spring pressure, holding the leg sections 27, 28, at that position. Additional force applied to the moving leg sections 27, 28, will push the ball back into its cylinder, compressing the spring, and allowing the leg sections 27, 28, to move to another position. In yet further embodiments, leg adjustment lock 32 may comprise a locking pin which may be inserted through one or more pin apertures in two leg sections 27, 28, thereby removably securing the leg sections 27, 28, together. In alternative embodiments, leg adjustment lock 32 may comprise any other coupling method which may be used to couple, preferably movably or removably, two or more leg sections 27, 28, together.

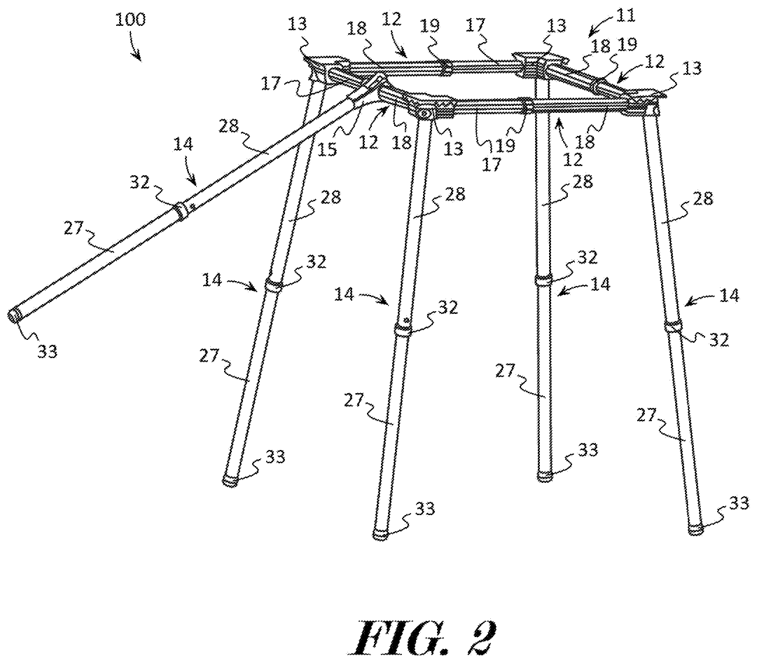

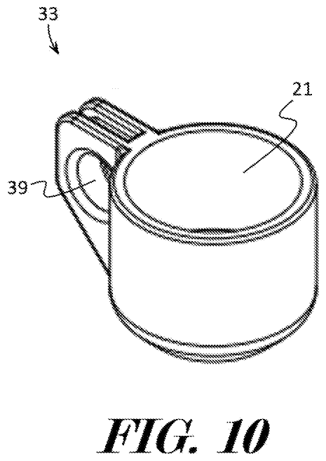

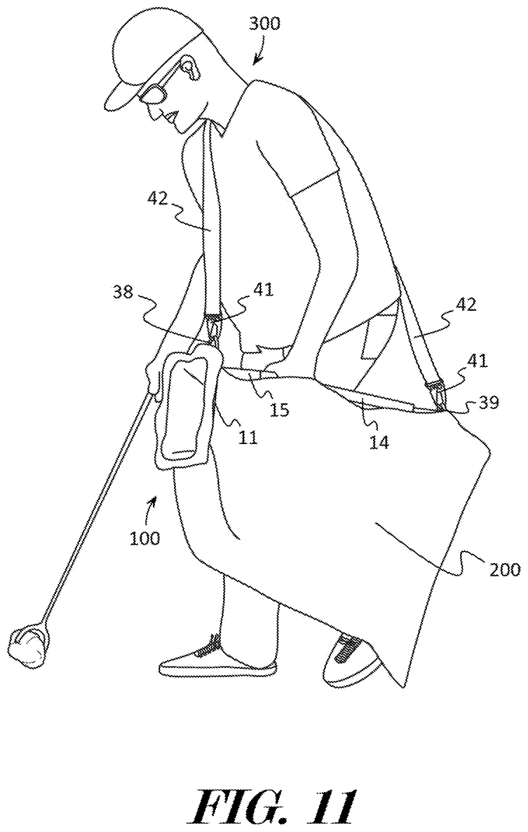

As perhaps best shown in FIGS. 2 and 10, in some embodiments, the device may comprise one or more feet 33. Preferably, a foot 33 which may be coupled to the end of the leg 14 which is distal to a bag retaining structure 11 that the leg 14 may be coupled to. A foot 33 may be made from any material, such as rubber, plastic, metal or metal alloys, and configured in any shape and size. For example, a foot 33 may be configured which a generally convex shape and formed of rubber to prevent the foot 33 from slipping or damaging surfaces. As another example, a foot 33 may be configured with a generally pointed shape and formed from a metal alloy so that the foot 33 may be insert-able into a ground surface to prevent the device from blowing away or falling over. In alternative embodiments, a leg 14 may comprise a wheel 34 or other transportation conveyance which may facilitate the movement of the device 100 over a ground surface.

In some embodiments, a foot 33 may comprise a foot aperture 39 which may facilitate the coupling or attachment of the foot 33 to various objects. For example, when the device 100 is standing being supported on a ground surface by one or more legs 14 having a foot 33, a wire tent peg or the like can be inserted through the foot aperture 39 to help to keep the device 100 solid to the ground on a windy day. As another example, the foot aperture 39 may also provide an attachment point for a shoulder strap fastener 41 of a shoulder strap 42. A foot aperture 39 may be configured in any shape or size, such as a generally circular shape.

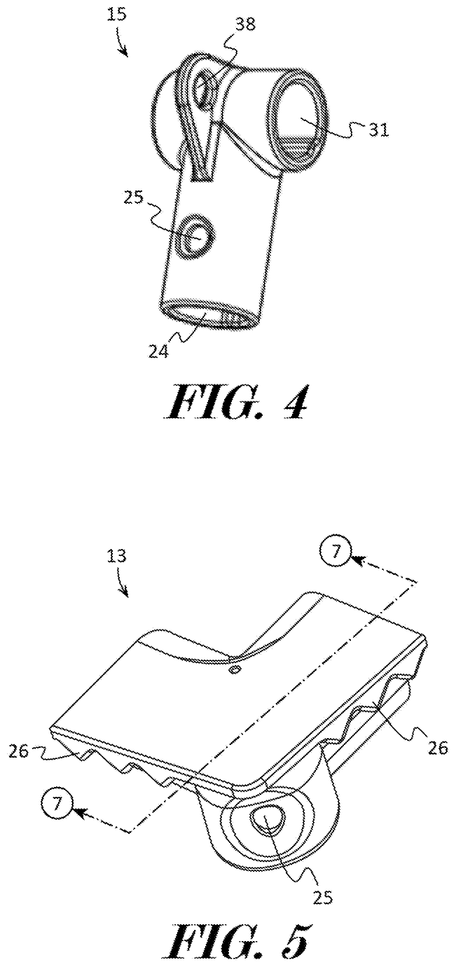

In further embodiments, and as shown in FIGS. 1 and 2, a leg 14 may be coupled to the bag retaining structure 11 by a handle coupler 15. Also referring to FIG. 4, a handle coupler 15 may comprise a leg coupler 24 and a rail conduit 31. The leg coupler 24 may enable a leg 14 to be coupled to the handle coupler 15, while a rail conduit 31 may enable the handle coupler 15 to be coupled to a rail 12 of the bag retaining structure 11. Optionally, a handle coupler 15 may comprise one or more fastener apertures 38. Also referring to the example device 100 shown in FIG. 1, the device 100 may be held by a user by a leg 14 coupled to the retaining structure 11 via a handle coupler 15. In this manner, the device 100 may be carried by the user while the bag retaining structure 11 secures a bag 200 so that the user may move about while being able to place objects into and out of the bag 200.

Just as with a leg coupler 24 of a corner joiner 13, a leg coupler 24 of a handle coupler 15 may comprise any shape which may be suitable for receiving portions, such as an end portion, of a leg 14. Similar to a rail coupler 21 of a corner joiner 13, a rail conduit 31 of a handle coupler 15 may comprise any shape which may be suitable for receiving portions, such as a middle portion, of a rail 12. Preferably, a rail conduit 31 may extend through a handle coupler 15 so that a handle coupler 15 may be coupled to a rail 12 by inserting portions of the rail 12 through the rail conduit 31 until the handle coupler 15 is positioned at a desired location on the rail 12. In some embodiments, apportion of a leg 14 may be coupled to a handle coupler 15 by being frictionally retained in a leg coupler 24. In other embodiments, a leg coupler 24 may comprise a leg lock 25 which may couple, preferably removably couple, a portion of a leg 14 within a leg coupler 24. In other embodiments, a leg 14 may be removably coupled to a handle coupler 15 via a ball detent arrangement. For example, a leg 14 may comprise a plunger 23 (FIG. 19) and a handle coupler 15 may comprise a detent aperture 25 thereby forming a ball detent arrangement so that the ball of a plunger 23 may fit into a hole shaped detent aperture 25 in the handle coupler 15. In other embodiments, a leg 14 may be coupled to a handle coupler 15 with a threaded engagement, via one or more fasteners, or with any other suitable coupling method.

In some embodiments, a handle coupler 15 may be coupled to a rail 12 by the insertion of the rail 12 through the rail conduit 31 via a frictional fit. Additionally, the rail conduit 31 and the rail 12 may comprise a complementary cross sectional shape, such as a hexagon, triangle, square, oval, or any other shape, so that the handle coupler 15 may be prevented from rotating around the rail 12 disposed within its rail conduit 31. In other embodiments, a rail conduit 31 may comprise a rail lock 23 which may couple, preferably removably couple, a portion of a rail 12 within a rail conduit 31. In other embodiments, a rail 12 may be coupled to a rail conduit 31 with a threaded engagement, via one or more fasteners, or with any other suitable coupling method.

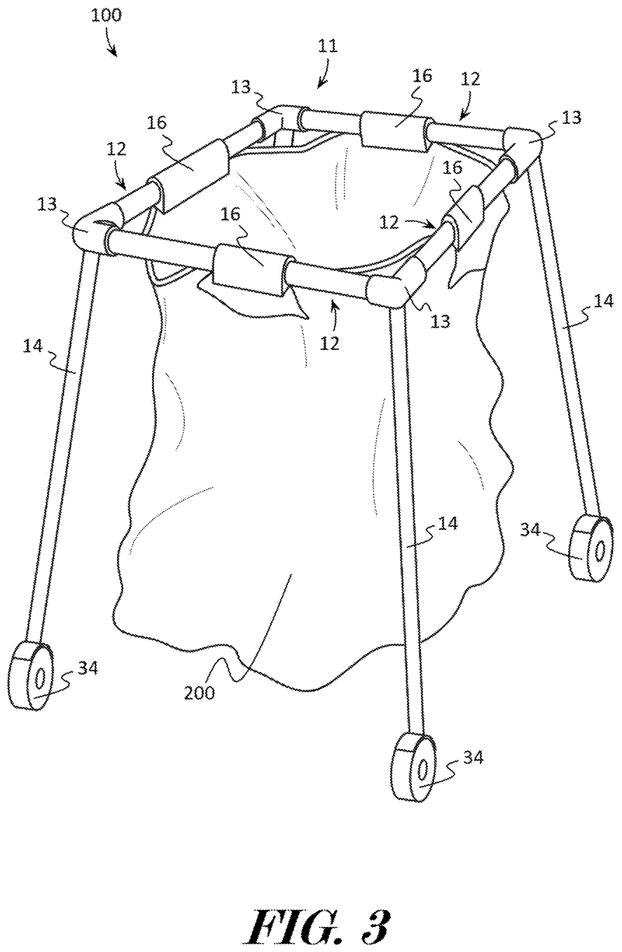

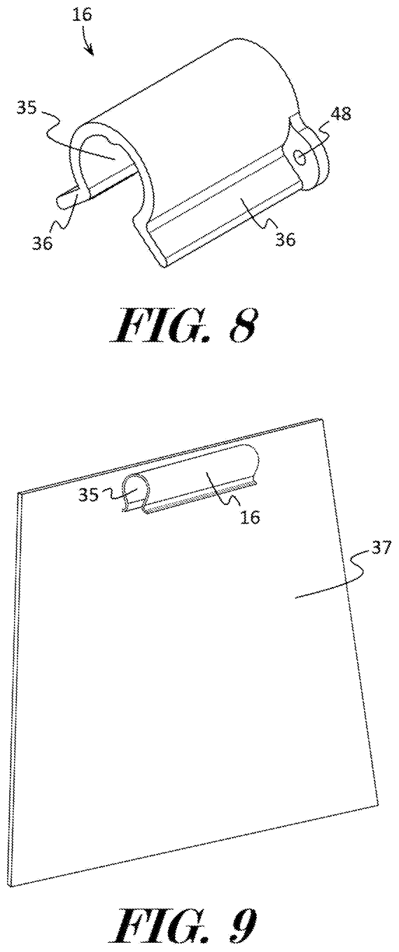

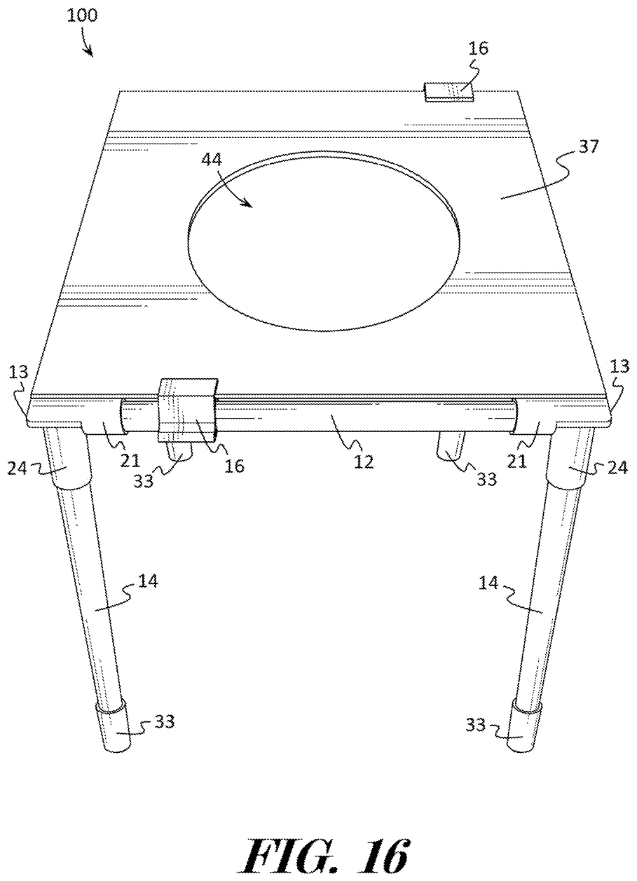

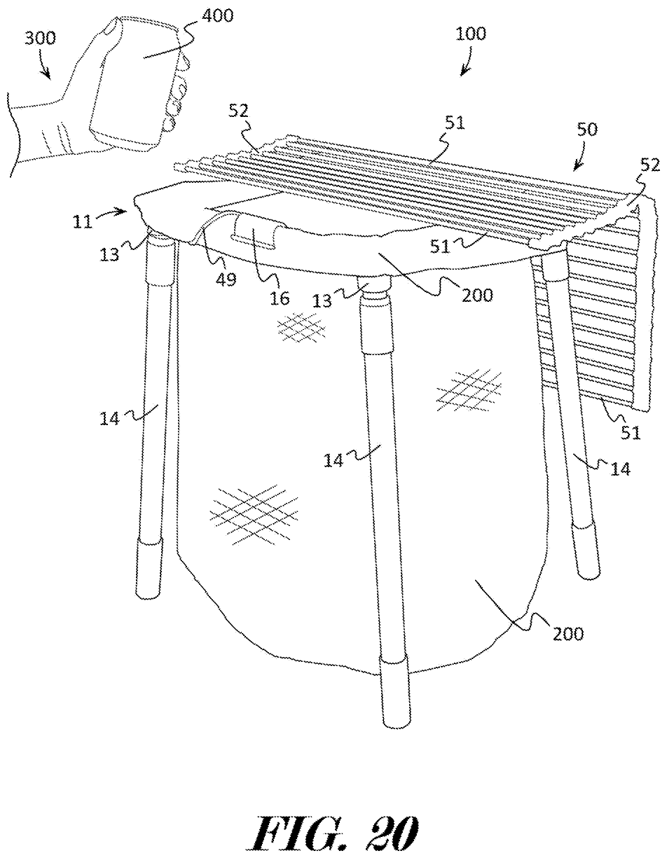

FIGS. 8, 14, and 15 illustrate examples of a rail retainer 16 according to various embodiments described herein. In some embodiments, the device 100 may comprise a rail retainer 16 which may be configured to removably couple portions of an object, such as a bag 200 (FIG. 3) or plate 43 (FIG. 16) to a rail 12 or leg 14. Preferably, the rail retainer 16 may comprise or be made from a flexible material, such as plastic, to enable the rail retainer 16 to flex over and around portions of a rail 12 or leg 14. In further embodiments, a rail retainer 16 may comprise a retainer channel 35 into which portions of a rail 12 or leg 14 (and optionally portions of a bag 200) may be received. A portion of a rail 12 or leg 14 may be frictionally coupled within a retainer channel 35 so that a portion of a bag 200 may be frictionally retained between the rail 12 and a rail retainer 16. The rail retainer 16 may comprise one or more lips 36 which may facilitate the retainer channel 35 being press fit over a portion of a bag 200 and a portion of a rail 12. In some embodiments, an element of the device 100, such as a rail retainer 16, may comprise a securement aperture 48 which may be configured to receive a securement fastener 49 (FIG. 20), such as a rope, string, chain, cord, elastic element, etc. which may be used to secure the element of the device 100, such as a rail retainer 16, to another element of the device 100. In preferred embodiments, a securement fastener 49 may be coupled to a detent aperture 25 or other aperture formed into a corner joiner 13. The securement aperture 48 and securement fastener 49 may be used to prevent small elements, such as a rail retainer 16, from being lost during storage, transit, or otherwise when not in use. In other embodiments, a rail retainer 16 may comprise fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method.

Turning now to FIG. 9, in some embodiments, the device 100 may comprise one or more plates 37 which may be of any shape and size. A plate 37 may be coupled anywhere on the device 100. Generally, a plate 37 may provide a surface for advertising or other indicia to be applied. Optionally, a plate 37 may be coupled to the device 100 so that the plate 37 may be positioned on or above all or portions of the bag retaining structure 11. In preferred embodiments, a plate 37 may be sized, shape, and coupled to the device 100 so that the plate 37 may generally function as a sidewall which may generally cover one side of the device 100 (a side being formed between two adjacent legs 14 and two corner joiners 13 joined via rail 12). For example, a device 100 comprising four legs 14, four corner joiners 13, and four rails 12, may have four plates 37 with one plate 37 coupled to each vertical side of the device 100. In some embodiments, a plate 37 may be coupled to a rail retainer 16 which may be used to removably couple the plate 37 to a rail 12 or leg 14 (and optionally also a portion of a bag 200). In other embodiments, a plate 37 may be coupled to one or more elements of the device 100 with fasteners or any other suitable coupling method.

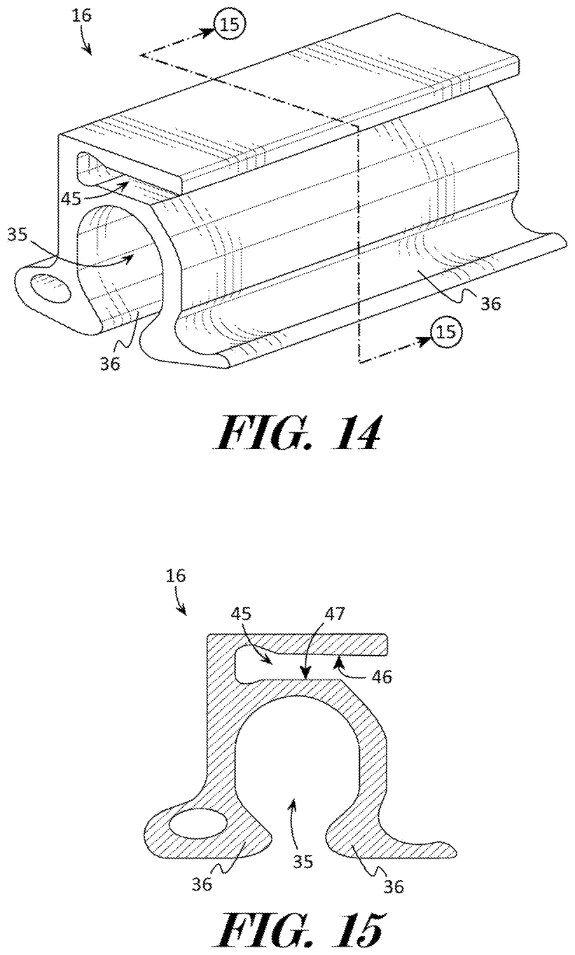

In some embodiments and as shown by FIGS. 14 and 15, a rail retainer 16 may comprise a slot 45. Preferably, a slot 45 may comprise a channel, depression, or the like, which may be shaped to receive generally planar shaped objects, such as a plate 37. A slot 45 may comprise an upper surface 46 and an opposing lower surface 47. In preferred embodiments, an object, such as a plate 37, may be frictionally retained in the slot 45. For example, when an object, such as a plate 37 is inserted into the slot 45, the object may force the upper surface 46 and lower surface 47 away from each other so that the upper surface 46 and lower surface 47 may be frictionally engaged to the object.

In some embodiments, a plate 37 may be coupled to one or more rails 12 so that the plate 37 may be disposed above the bag retaining structure 11. For example, portions of the plate 37 may be frictionally received in a slot 45 of the rail retainer 16 while portions of a rail 12 may be frictionally received in a retainer channel 35. In this manner, objects may be placed upon and supported above the bag retaining structure 11 (and a bag 200 if it is coupled to the bag retaining structure 11) by the plate 37. In further embodiments, a plate 37 may comprise a plate aperture 44 which may allow objects to pass through the plate 37 (and into a bag 200 if it is coupled to the bag retaining structure 11). As an example, a device 100 may function as a temporary trash receptacle by allowing users to deposit trash into a bag 200 coupled to the bag retaining structure 11 via a plate aperture 44 of a plate 37 that is disposed above the bag retaining structure 11. As another example, a device 100 may function as a temporary toilet by allowing users to optionally sit on the plate and deposit waste into a bag 200 coupled to the bag retaining structure 11 via a plate aperture 44 of a plate 37 that is disposed above the bag retaining structure 11.

In preferred embodiments, a plate 37 may be made from or may comprise Aluminum Composite Material (ACM), which is a very strong planar shaped material formed with plastic that has a thin aluminum surface on both sides. In other embodiments, a plate 37 may be made from or may comprise preferably planar shaped material, such as cardboard, wood sheet, plastic sheet, honeycomb plastic panels, corrugated plastic panels, poster board, metal sheet, such as aluminum, or any other material. It should be understood that a plate 37 is not limited to a planar shape, and that a plate 37 may be configured in any shape and size. For example, a plate 37 may comprise the shape of a toilet seat or any other object.

FIG. 11 illustrates a perspective view of a user 300 manipulating an exemplary reconfigurable bag holder device 100 via an exemplary shoulder strap 42 according to various embodiments described herein. In this example, the device 100 comprises a leg 14 coupled to the bag retaining structure 11 by a handle coupler 15. A foot 33 may be coupled to the end of the leg 14 that is distal to the handle coupler 15. The device 100 may comprise a shoulder strap 42 which may be coupled to one or more elements of the device 100, such as to a handle coupler 15 and a foot 33. A shoulder strap 42 may comprise a length of flexible material which may be suitable for supporting the device 100 and objects placed within a bag 200 retained by the device 100. In some embodiments, the shoulder strap 42 may comprise a length of Polypropylene webbing. In other embodiments, the shoulder strap 42 may be made of other materials, such as but not limited to, synthetic webbing such as nylon webbing, polyester webbing, velour, any elastic material, non-elastic material, woven material, fabric or cloth material, natural webbing such as cotton webbing, other non-fabric flexible materials such as silicone, rubber, plastics, or any other suitable strap type or rope type of material.

In preferred embodiments, the shoulder strap 42 may comprise one or more shoulder strap fasteners 41 which may be configured to couple, preferably removably couple, the shoulder strap 42 to one or more other elements of the device 100. In further preferred embodiments, a shoulder strap fastener 41 may be disposed on opposing ends of the shoulder strap 42, and one shoulder strap fastener 41 may be coupled to a fastener aperture 38 of a handle coupler 15 while the other shoulder strap fastener 41 may be coupled to a foot aperture 39 of a foot 33 as shown in FIG. 11. A shoulder strap fastener 41 may comprise a carabiner type fastener, a snap ring fastener, a snap hook fastener, or any other type of fastener which may preferably be removably coupled to one or more objects.

In some embodiments, and as shown in FIG. 20, the device 100 may comprise a collapsible table 50 which may be positioned on the bag retaining structure 11 so as to rest on portions of one or more rails 12 and corner joiners 13. Preferably, a collapsible table 50 may be positioned on the bag retaining structure 11 so that users 300 may still be able to deposit objects 400 into a bag 200 supported by the bag retaining structure 11. For example, a user 300 may place an object 400, such as a beverage container, on the collapsible table 50 and then deposit the object 400 into the bag 200 supported by the bag retaining structure 11 when they are finished with their beverage container object 400.

A collapsible table 50 may comprise any structure which may be suitable for supporting objects 400 and for being moved into and out of a folded or compacted shape. In preferred embodiments, a collapsible table 50 may comprise a plurality of slats 51 which may be coupled generally parallel to each other by one or more flexible slat couplers 52. The slat couplers 52 may allow the slats 51 to be moved proximate to each other so that the collapsible table 50 may be folded or otherwise reshaped so as to cover desired portions of a bag retaining structure 11 and to be compacted, optionally by rolling up the collapsible table 50, for storage and transit. A slat 51 may comprise an elongated length of substantially rigid material, such as aluminum tubing or bar stock, other metal tubing or bar stock, wood beams, plastic tubing or bar stock, or any other material. A slat coupler 52 may comprise fabric materials, such as canvas, nylon webbing, chain, cord, rope, articulating links, or any other material which may be movable and/or flexible.

While some exemplary shapes and sizes have been provided for elements of the device 100, it should be understood to one of ordinary skill in the art that a rail 12, corner joiner 13, leg 14, optional handle coupler 15, optional rail retainer 16, and/or any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

While some materials have been provided, in other embodiments, the elements that comprise the device 100 such as a rail 12, corner joiner 13, leg 14, optional handle coupler 15, optional rail retainer 16, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1) A reconfigurable bag holder device, the device comprising:
a) a bag retaining structure, the bag retaining structure having:
b) a first corner joiner having a first rail coupler, a second rail coupler, and a leg coupler;
c) a first rail coupled to the first rail coupler; and
d) a second rail coupled to the second rail coupler; and
e) a first leg coupled to the bag retaining structure.

2) The device of claim 1, wherein the first leg is coupled to the bag retaining structure by being coupled to the leg coupler of the first corner joiner.

3) The device of claim 1, wherein the first leg is coupled to the bag retaining structure by being coupled to the first rail via a handle coupler.

4) The device of claim 1, wherein a rail selected from the group consisting of the first rail and the second rail is adjustable in length.

5) The device of claim 1, wherein the first leg is adjustable in length.

6) The device of claim 1, wherein the device further comprises a third rail and a fourth rail, wherein the device further comprises a second corner joiner, a third corner joiner, and a fourth corner joiner, wherein the device further comprises a second leg, a third leg, and a fourth leg, wherein each rail is coupled to two corner joiners, and wherein a leg is removably coupled to each corner joiner.

7) The device of claim 1, further comprising a rail retainer.

8) The device of claim 7, wherein the rail retainer comprises a slot.

9) The device of claim 1, further comprising a shoulder strap.

10) The device of claim 1, further comprising rail retainer, the rail retainer having a slot, and further comprising a plate, the plate having an aperture, wherein the rail retainer is coupled to the first rail, and wherein a portion of the plate is coupled to the rail retainer by being received in the slot.

11) The device of claim 1, wherein the first leg coupler is angled between 90 and 150 degrees relative to a horizontal rail plane formed by a projected intersection between the first rail coupler and second rail coupler.

12) A reconfigurable bag holder device, the device comprising:
a) a first corner joiner, a second corner joiner, a third corner joiner, and a fourth corner joiner, wherein each corner joiner comprises two rail couplers and a leg coupler, and wherein the first corner joiner has a first rail coupler, a second rail coupler, and a first leg coupler;
b) a first rail, a second rail, a third rail, and a fourth rail, wherein the first rail is coupled to the first rail coupler and the second rail is coupled to the second rail coupler, and wherein at least one rail is adjustable in length; and
c) a first leg, a second leg, a third leg, and a fourth leg, wherein the first leg is coupled to the first leg coupler.

13) The device of claim 12, further comprising a handle coupler.

14) The device of claim 12, wherein a rail selected from the group consisting of the first rail, second rail, third rail, and fourth rail is adjustable in length.

15) The device of claim 12, wherein a leg selected from the group consisting of the first leg, second leg, third leg, and fourth leg is adjustable in length.

16) The device of claim 12, further comprising a rail retainer.

17) The device of claim 16, wherein the rail retainer comprises a slot.

18) The device of claim 12, further comprising a shoulder strap.

19) The device of claim 12, further comprising rail retainer, the rail retainer having a slot, and further comprising a plate, the plate having an aperture, wherein the rail retainer is coupled to the first rail, and wherein a portion of the plate is coupled to the rail retainer by being received in the slot.

20) The device of claim 12, wherein the first leg coupler is angled between 90 and 150 degrees relative to a horizontal rail plane formed by a projected intersection between the first rail coupler and second rail coupler.
